(19) United States
(12) Patent Application Publication
(10) Pub. No.: US 2024/0172204 A1
(43) Pub. Date: May 23, 2024

(54) TERMINAL DEVICE FOR REDUCING WIRELESS COMMUNICATION LATENCY, CONTROL METHOD, AND COMPUTER-READABLE STORAGE MEDIUM

(71) Applicant: KDDI CORPORATION, Tokyo (JP)

(72) Inventors: Masaya SHIBAYAMA, Tokyo (JP); Masahito UMEHARA, Tokyo (JP)

(21) Appl. No.: 18/430,721

(22) Filed: Feb. 2, 2024

Related U.S. Application Data
(63) Continuation of application No. PCT/JP2022/025722, filed on Jun. 28, 2022.

(30) Foreign Application Priority Data
Aug. 11, 2021 (JP) 2021-131329

(51) Int. Cl. H04W 72/0453; H04L 5/00

(52) U.S. Cl. CPC H04W 72/0453; H04L 5/0094

(57) ABSTRACT

A terminal device, which is configured to execute reception processing including Fourier transform targeting a range of a predetermined frequency band on a received signal, execute, in a case where a signal transmitted from a base station device with a first frequency resource and a signal transmitted from another terminal device with a second frequency resource are included in the range of the predetermined frequency band, control to execute the reception processing including the Fourier transform on the first frequency resource and to not execute the reception processing including the Fourier transform on the second frequency resource.

### CROSS-REFERENCE TO RELATED APPLICATION(S)

This application is a continuation of International Patent Application No. PCT/JP2022/025722 filed on Jun. 28, 2022, which claims priority to and the benefit of Japanese Patent Application No. 2021-131329 filed on Aug. 11, 2021, the entire disclosures of which are incorporated herein by reference.

### BACKGROUND OF THE INVENTION

### Field of the Invention

The present invention relates to a technology for reducing wireless communication latency in a cellular communication system.

### Description of the Related Art

There is demand for low-latency communication in cellular communication systems, and the Third Generation Partnership Project (3GPP®) has been researching technologies for realizing ultra-reliable and low latency communications (URLLC).

The present invention provides a technology for reducing wireless communication latency in a cellular communication system.

### SUMMARY OF THE INVENTION

According to one aspect of the present invention, there is provided a terminal device comprising: one or more processors; and one or more memories that store a computer-readable instruction for causing, when executed by the one or more processors, the one or more processors to: execute reception processing including Fourier transform targeting a range of a predetermined frequency band on a received signal; and execute, in a case where a signal transmitted from a base station device with a first frequency resource and a signal transmitted from another terminal device with a second frequency resource are included in the range of the predetermined frequency band, control to execute the reception processing including the Fourier transform on the first frequency resource and to not execute the reception processing including the Fourier transform on the second frequency resource.

Further features of the present invention will become apparent from the following description of exemplary embodiments with reference to the attached drawings.

### BRIEF DESCRIPTION OF THE DRAWINGS

FIG. 1 is a diagram showing an example configuration of a wireless communication system.

FIG. 2 is a diagram showing an example of allocation of resources to uplink/downlink communication.

FIG. 3 is a diagram showing an example hardware configuration of a base station device and a terminal device.

FIG. 4 is a diagram showing an example functional configuration of the terminal device.

FIG. 5 is a diagram showing an example functional configuration of the base station device.

FIG. 6 is a diagram showing an example of the flow of processing that is executed in the wireless communication system.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### Configuration of Communication System

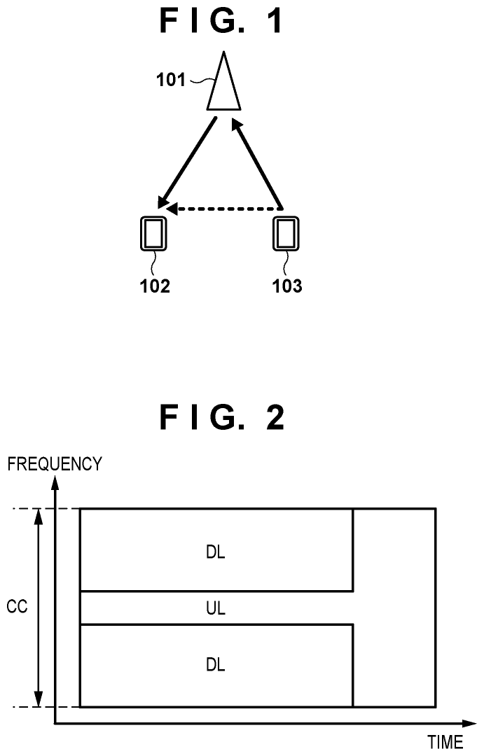

FIG. 1 shows an example configuration of a wireless communication system according to the present embodiment. The wireless communication system is, for example, a wireless communication system compliant with the fifth-generation (5G) cellular wireless communication standard defined by the Third Generation Partnership Project (3GPP®). Note that this system is given as an example, and other wireless communication systems may be used. The wireless communication system includes a base station device 101, a terminal device 102 and a terminal device 103, for example. Communication between the base station device 101 and the terminal devices 102 and 103 can be performed using a technique that involves generating signals of time regions by mapping signals to be transmitted on a frequency axis and performing Fourier transform, such as orthogonal frequency-division multiple access (OFDMA). Note that FIG. 1 shows only a small number of base station and terminal devices in order to simplify description, but there can of course be a larger number of base station and terminal devices.

In this wireless communication system, time division duplex (TDD) is used in communication between the base station device and the terminal devices. In TDD, a common frequency resource is divided into timeslots, and the plurality of timeslots are each allocated to either an uplink (link from terminal device to base station device) or a downlink (link from base station device to terminal device). Here, the procedure when transmitting data on the uplink involves a terminal device transmitting a scheduling request (SR) to the base station device, the base station device allocating a wireless resource to the terminal device in order to prompt transmission of a buffer status report (BSR), the terminal device transmitting the BSR with the allocated wireless resource, the base station device allocating a wireless resource for data transmission based on the BSR, and the terminal device transmitting data with the allocated wireless resource. At this time, in a system using TDD, after the SR is transmitted to the base station device with an uplink resource, wireless resource allocation for the BSR is notified to the terminal device with a downlink resource, the BSR is transmitted to the base station device with a subsequent uplink resource, wireless resource allocation for data transmission is performed with a subsequent downlink resource, and data is transmitted with a subsequent uplink resource. The period from the time that the terminal device transmits the SR until the time that data is actually transmitted can thus become prolonged.

Thus, in the present embodiment, as shown in FIG. 2, a timeslot allocated to the downlink (DL) with one frequency resource is allocated for the uplink (UL) in another frequency resource. Note that FIG. 2 shows an example in which a frequency resource that is used only for uplink communication is provided in the middle of the frequency range of a component carrier (CC). In this way, the abovementioned period can be shortened, by allocating the timeslot that is allocated to the downlink in the first frequency resource to the uplink in the second frequency resource. Note that allocation of a timeslot to uplink communication and downlink communication such as is shown in FIG. 2 is an example, and other allocation of timeslots may be used. For example, the allocation of the downlink and the uplink in the first frequency resource in portions other than the middle of the CC may be such that more downlink or uplink timeslots are provided. Also, in the second frequency resource in the middle portion of the CC, no timeslots are allocated to downlink communication, but some timeslots may be allocated for downlink communication. That is, within the CC, any allocation may be used to the extent that a configuration is achieved in which there is a first frequency resource that uses a first allocation of timeslots to the downlink and the uplink and a second frequency resource that uses a second allocation thereof. Note that the above describes frequency resources with different timeslot allocations within the range of the CC, but the present invention is not limited thereto. The above-described CC may be interpreted as a predetermined frequency band in which reception processing including fast Fourier transform (FFT) is collectively performed in the terminal device.

That is, if data to be transmitted occurs in a timeslot allocated to the downlink in the first frequency resource, for example, the terminal device is able to transmit an SR with the second frequency resource, without waiting for a timeslot allocated to the uplink in the first frequency resource to arrive. Also, if the base station device receives an SR during the period allocated to the downlink in the first frequency resource, a signal for allocating a wireless resource for a BSR can be transmitted with the first frequency resource during that period. Here, by using the second frequency resource, a wireless resource can be allocated for a BSR during the period in which the first frequency resource is allocated to the downlink. The terminal device is thus able to transmit a BSR with the second frequency resource, without waiting for a timeslot in which the first frequency resource is allocated to the uplink. Thereafter, if a BSR is received during a period allocated to the downlink in the first frequency resource, the base station device is able to transmit a signal for allocating a wireless resource for data with the first frequency resource during that period. The terminal device is able to transmit data with the second frequency resource, without waiting for a timeslot in which the first frequency resource is allocated to the uplink.

In this way, in the present embodiment, a first frequency resource that follows a first allocation of timeslots to uplink communication and downlink communication and a second frequency resource that follows a second allocation that differs from the first allocation are provided. Also, it is possible to use timeslots allocated to the downlink in the first frequency resource and timeslots allocated to the uplink in the second frequency resource. As described above, for example, transmission of SRs, BSRs and the like can thereby be executed with the second frequency resource, without waiting for a timeslot allocated to the uplink in the first frequency resource, and the period for data of the uplink to be transmitted can be shortened.

On the other hand, in the case of using the configuration shown in FIG. 2, uplink communication and downlink communication are performed in the same timeslot. For example, as shown in FIG. 1, if a signal is transmitted from the base station device 101 to the terminal device 102 with the first frequency resource, a signal can be transmitted from the terminal device 103 to the base station device 101 with the second frequency resource. In this case, the terminal device 102 receives the signal from the base station device 101 in parallel with the signal from the terminal device 103, and collectively executes reception processing including Fourier transform on these signals. At this time, if the terminal device 103 is located in the vicinity of the terminal device 102, for example, the reception power of the signal transmitted by the terminal device 103 in the terminal device 102 can be significantly larger than the reception power of the signal transmitted from the base station device 101 in the terminal device 102. In this case, the signal from the terminal device 103 can have dominant power over all received signals. As a result, the signal from the base station device 101 can get buried in the noise level, and the terminal device 102 can fail to receive the signal. Also, although the terminal device 103 adjusts the transmission timing, such that the timings at which the base station device 101 receives OFDM symbols from a plurality of terminal devices substantially coincide, this transmission timing does not take into consideration the reception timing in the terminal device 102. Thus, when the terminal device 102 performs Fourier transform at a timing based on a signal received from the base station device 101, the orthogonality of the signal received from the terminal device 103 can be disrupted, and the signal from the base station device 101 can be affected by interference.

In the present embodiment, the terminal device 102 executes processing for reducing the influence of the signal from the terminal device 103. That is, the terminal device 102 of the present embodiment is configured to be able to execute reception processing including Fourier transform targeting the range of a predetermined frequency band (CC, etc.), for example, and performs control to exclude some frequency resources from the Fourier transform in the range of the predetermined frequency band. Note that the range of the predetermined frequency band is a sufficiently large bandwidth such as a 100 MHz bandwidth, for example. For example, if a signal transmitted from the base station device 101 with the first frequency resource and a signal transmitted from another terminal device 103 with the second frequency resource are included, the terminal device 102 does not execute reception processing including Fourier transform on the second frequency resource. For example, by setting a bandwidth part (BWP) that includes a first frequency resource and does not include a second frequency resource as a range of frequency resources that are to execute reception processing including Fourier transform, the terminal device 102 can execute demodulation processing including Fourier transform on the signal from the base station device 101 and not execute demodulation processing on the signal from the terminal device 103. Note that the BWP can be set in units of subframes or timeslots. That is, setting of different BWPs may be used for each of the plurality of subframes or timeslots in one frame. For example, setting can be performed such that, in subframes/timeslots in which both the first frequency resource and the second frequency resource are used in signal transmission by the base station device 101, a BWP that includes both the first frequency resource and the second frequency resource is used, and the first frequency resource is used in signal transmission by the base station device 101, and, in subframes/timeslots in which the second frequency resource is used in signal transmission by the terminal device 103, a BWP that includes the first frequency resource and does not include the second frequency resource is used. If a BWP that includes both the first frequency resource and the second frequency resource is set, the terminal device 102 executes reception processing including Fourier transform on frequency resources including the first frequency resource and the second frequency resource. On the other hand, if a BWP that includes the first frequency resource and does not include the second frequency resource is set, the terminal device 102 executes reception processing including Fourier transform on the first frequency resource and does not execute reception processing including Fourier transform on the second frequency resource.

Note that, when the terminal device 103 transmits a signal in the second frequency resource at the time of reception processing including Fourier transform or the like, the terminal device 102 may suppress the signal component of the second frequency resource, using a band-limiting filter or the like in which the second frequency resource is set as the stopband. That is, instead of or in addition to setting a BWP, processing for reducing the influence of the signal component of the second frequency resource through suppression thereof is performed, and reception processing including Fourier transform of the signal in the first frequency resource may be performed for the signal after suppression. This processing can also be performed for each subframe/timeslot, such as setting the stopband based on whether the terminal device 103 transmits a signal in the second frequency resource.

Note that in the case where a BWP is used, a message for setting the BWP can be transmitted from the base station device 101 to the terminal device 102, and the terminal device 102 can set the BWP in accordance with the message. Note that, regarding the message for setting the BWP, a radio resource control (RRC) message, for example, is used to set the BWP. Here, the base station device 101 may notify information designating setting of a plurality of BWPs for each subframe/timeslot to the terminal device 102. Also, the message for setting the BWP may be a different message from an RRC message. For example, setting of a plurality of BWPs may be notified by an RRC message or a notification signal, and which BWP is to be used may be designated using downlink control information (DCI).

Hereinafter, an example configuration of the base station device 101 and the terminal device 102 that execute processing such as described above and an example of the flow of processing that is executed will be described.

### Device Configuration

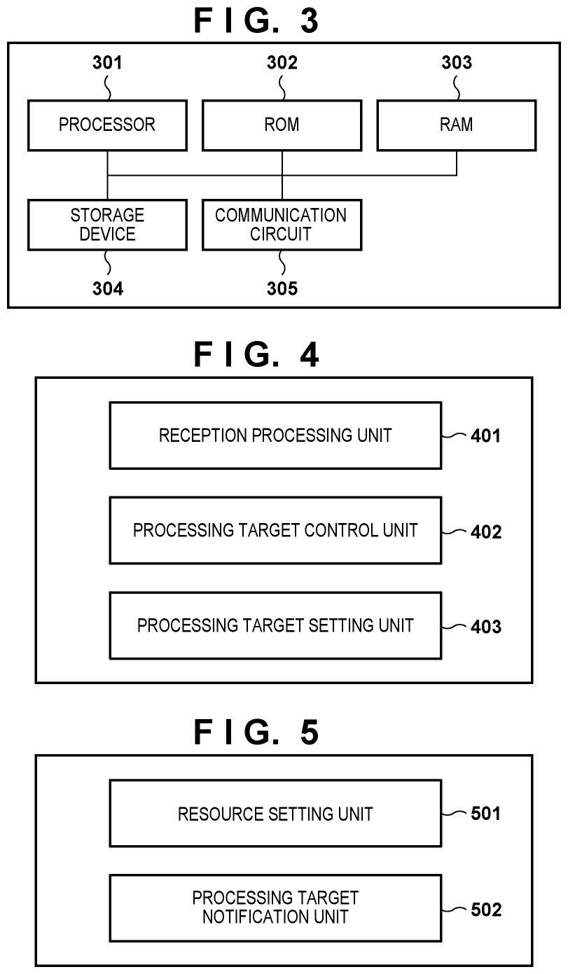

An example hardware configuration of the base station device 101 and the terminal device 102 will now be described, using FIG. 3. Note that the terminal device 103 may also have a similar hardware configuration. The base station device 101 and the terminal device 102, in one example, are constituted to include a processor 301, a ROM 302, a RAM 303, a storage device 304 and a communication circuit 305. The processor 301 is a computer constituted to include one or more processing circuits such as a general-purpose CPU (central processing unit) and an ASIC (application-specific integrated circuit), and executes overall processing of the device and the respective processing described above, by reading out and executing programs stored in the ROM 302 or the storage device 304. The ROM 302 is a read-only memory that stores information such as programs and various parameters relating to the processing that is executed by the base station device 101 and the terminal device 102. The RAM 303 is a random access memory that functions as a workspace for the processor 301 to execute programs and also stores temporary information. The storage device 304 is constituted by a removable external storage device, for example. The communication circuit 305 is, for example, constituted by a circuit for LTE or 5G wireless communication. Note that, in FIG. 3, one communication circuit 305 is illustrated, but the base station device 101 and the terminal device 102 can have a plurality of communication circuits. For example, the base station device 101 and the terminal device 102 can have a common antenna for the LTE and 5G wireless communication circuits. Note that the base station device 101 and the terminal device 102 also may have separate LTE and 5G antennas. Also, the base station device 101 may have, for example, a communication circuit for wired communication for communication with other base station devices and network nodes, and the terminal device 102 may have a communication circuit for other wireless communication systems such as wireless LAN. Note that the base station device 101 and the terminal device 102 may have separate communication circuits 305 for each of a plurality of available frequency bands, or may have a common communication circuit 305 for at least some of the frequency bands.

FIG. 4 is a diagram showing an example functional configuration of the terminal device 102. The terminal device 102 includes, as functions thereof, a reception processing unit 401, a processing target control unit 402 and a processing target setting unit 403, for example. Note that these functional units can be realized by, for example, the processor 301 executing a program stored in the ROM 302 or the storage device 304.

The reception processing unit 401 executes reception processing such as FFT (fast Fourier transform), demodulation and decoding on signal components within the range of a predetermined frequency band, with regard to received signals. The processing target control unit 402 controls the reception processing unit 401 to only execute reception processing for frequency resources within the range of the predetermined frequency band targeted for processing by the reception processing unit 401. The processing target setting unit 403 determines and sets frequency resources to be targeted for reception processing within the range of the predetermined frequency band. The processing target setting unit 403 sets a frequency resource to be targeted for reception processing by setting a BWP, for example. For example, if the base station device 101 transmits a signal with the first frequency resource and the terminal device 103 transmits a signal with the second frequency resource, the processing target setting unit 403 sets a BWP that includes the first frequency resource but does not include the second frequency resource. Also, if the base station device 101 transmits signals with the first frequency resource and the second frequency resource, the processing target setting unit 403 sets a BWP that includes both the first frequency resource and the second frequency resource. Then, based on control by the processing target control unit 402, the reception processing unit 401 executes reception processing including Fourier transform in relation to the first frequency resource with which the base station device 101 transmitted the signal, and does not execute reception processing in relation to the second frequency resource with which the terminal device 103 transmitted the signal. Also, the reception processing unit 401 may further execute processing for suppressing the signal component of the second frequency resource, using a band-limiting filter in which the second frequency resource is set as the stopband, for example. Also, if both the first frequency resource and the second frequency resource are used in signal transmission by the base station device 101, the reception processing unit 401 executes reception processing on both the first frequency resource and the second frequency resource. Note that the signal transmitted from the base station device 101 in the first frequency resource or the second frequency resource may not necessarily include data addressed to the terminal device 102. That is, it is sufficient for the frequency resource with which the signal is transmitted from the terminal device 103 to be excluded from being targeted for reception processing.

FIG. 5 is a diagram showing an example functional configuration of the base station device 101. The base station device 101 is constituted to include, as functions thereof, a resource setting unit 501 and a processing target notification unit 502, for example. Note that these functional units can be realized by the processor 301 executing a program stored in the ROM 302 or the storage device 304, for example.

The resource setting unit 501 sets the allocation of timeslots of the uplink and the downlink by TDD for each frequency resource. For example, the resource setting unit 501 sets an allocation of timeslots such as is shown in FIG. 2, and communicates with a subordinate terminal device, based on the timeslot allocation setting. The processing target notification unit 502 notifies, to the terminal device 102, information designating a frequency resource with which a terminal device such as the terminal device 102 is to perform reception processing, based on the timeslot allocation setting. Note that the processing target notification unit 502 can notify information designating a frequency resource with which to perform the reception processing, in units of time based on the length of time taken to switch the uplink and downlink by TDD, such as in units of timeslots or subframes. The processing target notification unit 502 can notify a BWP to be set in the terminal device 102 to the terminal device 102 as information designating a frequency resource with which to perform reception processing, for example.

### Flow of Processing

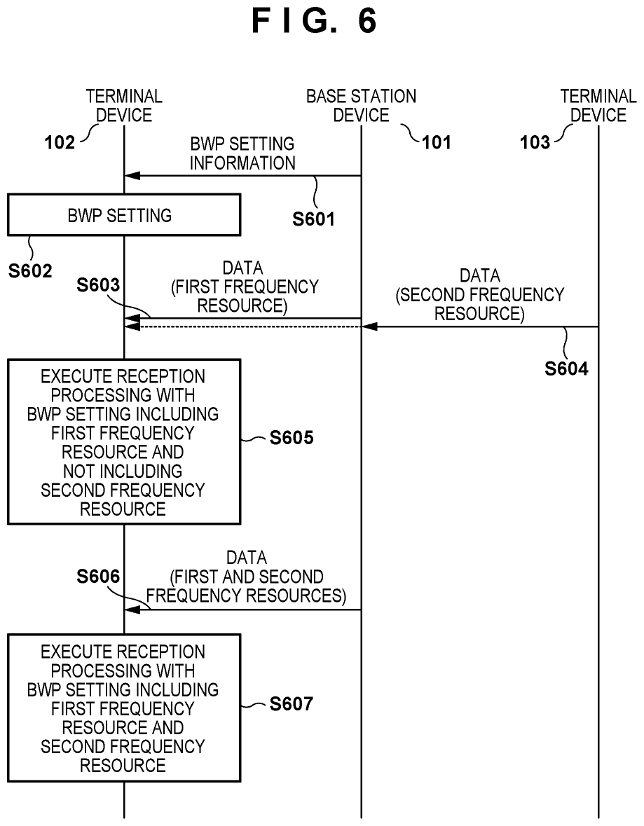

Next, an example of the flow of processing that is executed in the wireless communication system will be described with reference to FIG. 6. It should be noted that the flow of processing described below is an example, and transformation such as described above is naturally possible.

In this processing, the base station device 101 notifies information indicating setting of a BWP to a connected terminal device 102 (step S601). Note that the notified information may be information in which combinations of a frequency resource and a timeslot are associated with allocations to the uplink/downlink. That is, the terminal device 102 receives notification of information capable of specifying at least one of a frequency resource with which to perform reception processing and a frequency resource to be excluded from being targeted for reception processing. Note that the base station device 101 may notify information designating the target of reception processing, such as a BWP to be set in the terminal device, to a terminal that is not connected, using a system information block (SIB), for example. Note that this information may be information in which frequency resources and time resources are associated, such as information of a BWP which is to be set for each unit of time such as for each timeslot/subframe. The terminal device 102 sets the BWP based on information indicating the setting of the BWP received in step S601 (step S602).

If notification of information designating the target of reception processing for each timeslot, subframe or the like is received, the terminal device 102 can change the setting over time, based on that information. For example, if the base station device 101 transmits a signal to the terminal device 102 with the first frequency resource (step S603) and the terminal device 103 transmits a signal to the base station device 101 with the second frequency resource (step S604), the terminal device 102 sets the first frequency resource as a target of reception processing and does not set the second frequency resource as a target of reception processing. As an example, the terminal device 102 sets a BWP that includes the first frequency resource and does not include the second frequency resource, and executes processing for receiving a signal from the base station device 101 (step S605). That is, the terminal device 102 ensures that the signal transmitted from the terminal device 103 is not subjected to reception processing such as FFT. In one example, the terminal device 102 can execute reception processing such as FFT after suppressing the component of the second frequency resource of the received signal using a band-limiting filter in which at least part of the second frequency resource is set as the stopband. Also, the terminal device 102 can be configured to not be affected by the signal component of the second frequency resource, by setting the first frequency resource as the target of FFT. The probability of failing to receive the signal from the base station device 101 can thereby be reduced, even if an environment where the signal from the terminal device 103 is received with sufficiently large power.

Also, if the base station device 101 transmits data using both the first frequency resource and the second frequency resource (step S606), the terminal device 102 sets not only the first frequency resource but also the second frequency resource as the target of reception processing. That is, the terminal device 102 sets a BWP that includes both the first frequency resource and the second frequency resource (or cancels the BWP setting and sets all of the predetermined frequency bands of the CC or the like as the target of reception processing), and executes reception processing of the signal from the base station device 101 (step S607). If part of a frequency resource is used in the uplink during only part of the time interval in which the frequency resource is used in the downlink, the frequency resource can thereby be included as a target of the reception processing and utilized effectively in that time interval.

Note that if the base station device 101 also transmits similar information to the terminal device 103, and the terminal device 103 receives the signal from the base station device 101, the terminal device 103 can execute the reception processing described in relation to the terminal device 102.

By adopting this configuration, in a timeslot in which uplink communication and downlink communication are both performed, the terminal device is able to receive the signal of the downlink in a state where the influence of the signal of the frequency resource of the uplink is sufficiently reduced, by excluding the frequency resource allocated to the uplink from being targeted for reception processing. Also, by using a BWP in this processing, the above-described processing can be executed based on processing executable by a conventional terminal device, thus enabling the above-described processing to be applied without needing to greatly modify the system.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A terminal device comprising:
one or more processors; and
one or more memories that store a computer-readable instruction for causing, when executed by the one or more processors, the one or more processors to:
execute reception processing including Fourier transform targeting a range of a predetermined frequency band on a received signal; and
execute, in a case where a signal transmitted from a base station device with a first frequency resource and a signal transmitted from another terminal device with a second frequency resource are included in the range of the predetermined frequency band, control to execute the reception processing including the Fourier transform on the first frequency resource and to not execute the reception processing including the Fourier transform on the second frequency resource.

2. The terminal device according to claim 1, wherein the control includes
performing control to execute the reception processing including the Fourier transform on frequency resources including the first frequency resource and the second frequency resource, in a first timeslot in which a signal is transmitted from the base station device in both the first frequency resource and the second frequency resource, and
performing control to execute the reception processing including the Fourier transform on the first frequency resource and to not execute the reception processing including the Fourier transform on the second frequency resource, in a second timeslot in which a signal is transmitted from the base station device with the first frequency resource and a signal is transmitted from the other terminal device with the second frequency resource.

3. The terminal device according to claim 1, wherein the control includes performing control to execute the reception processing including the Fourier transform on the first frequency resource and to not execute the reception processing including the Fourier transform on the second frequency resource, by setting a bandwidth part including the first frequency resource and not including the second frequency resource.

4. The terminal device according to claim 3, wherein the control includes setting, for each timeslot, a bandwidth part including the first frequency resource and not including the second frequency resource or a bandwidth part including both the first frequency resource and the second frequency resource.

5. The terminal device according to claim 3, wherein the control includes
performing control to execute the reception processing including the Fourier transform on the first frequency resource and to not execute the reception processing including the Fourier transform on the second frequency resource, in a case where a bandwidth part including the first frequency resource and not including the second frequency resource is set, and
performing control to execute the reception processing including the Fourier transform on frequency resources including the first frequency resource and the second frequency resource, in a case where a bandwidth part including both the first frequency resource and the second frequency resource is set.

6. The terminal device according to claim 3, wherein the control includes setting the bandwidth part, based on a message for setting the bandwidth part received from the base station device.

7. A control method for execution by a terminal device configured to execute reception processing including Fourier transform targeting a range of a predetermined frequency band on a received signal, the method comprising:
executing, in a case where a signal transmitted from a base station device with a first frequency resource and a signal transmitted from another terminal device with a second frequency resource are included in the range of the predetermined frequency band, control to execute the reception processing including the Fourier transform on the first frequency resource and to not execute the reception processing including the Fourier transform on the second frequency resource.

8. A non-transitory computer-readable medium that stores a program for causing a computer provided in a terminal device configured to execute reception processing including Fourier transform targeting a range of a predetermined frequency band on a received signal to:
execute, in a case where a signal transmitted from a base station device with a first frequency resource and a signal transmitted from another terminal device with a second frequency resource are included in the range of the predetermined frequency band, control to execute the reception processing including the Fourier transform on the first frequency resource and to not execute the reception processing including the Fourier transform on the second frequency resource.
